(19) United States
(12) Patent Application Publication
(10) Pub. No.: US 2018/0114201 A1
(43) Pub. Date: Apr. 26, 2018

(54) UNIVERSAL PAYMENT AND TRANSACTION SYSTEM

(71) Applicant: Sani Kadharmestan, Jakarta (ID)

(72) Inventor: Sani Kadharmestan, Jakarta (ID)

(21) Appl. No.: 15/331,125

(22) Filed: Oct. 21, 2016

(51) Int. Cl. G06Q 20/10; G06Q 20/40

(52) U.S. Cl. CPC G06Q 20/10; G06Q 20/4016; G06Q 20/4014

(57) ABSTRACT

The universal payment system recognizes that near instantaneous electronic communication between all of the parties involved is possible today, and that because of this communication between the bank and customer during the transaction, it is not necessary for the customer to provide the merchant with semi-secret information to add validity to the transaction. With these two observations, the system is designed to overcome the limitations of existing payment systems, and to permit a wide variety of transactions that were difficult before. A transaction overseas that might once have seemed risky for a merchant due to the lengthy settlement period can now happen without a settlement period so that the merchant receives immediate payment as part of the transaction. Likewise, for the customer there is no longer the prospect of having to share sensitive information, such as a credit card number, with someone the customer does not even know.

### BACKGROUND

All businesses are based on some exchange of money for goods or services. Entertainment businesses may sell tickets to events, compact discs or other media for home enjoyment, and so forth. Restaurants sell food and an environment in which to eat and receive credit card, cash, and/or check payments. Retail stores sell goods that are typically paid for by cash, credit cards, checks, money orders, or other forms of payments. People may also exchange payments for various reasons, such as private sales of goods or services, gifts, loans or repayments, and so on. Some electronic payment systems exist, such as PayPal and Apple Pay, which use an email or NFC smartphone hardware to identify an individual and then act as an intermediary to the individuals existing forms of payment (e.g., bank accounts, credit cards, and so forth).

Business and personal transactions are increasingly international in nature. For example, businesses often manufacture goods in one country and sell those goods to many other countries. Buyers of goods may find an item they want in many countries other than their own, perhaps at more appealing prices. People that know each other from college, business, or other environments may live in different countries but want to exchange payments for gifts, goods, or services. In many cases, this is made more difficult by the fact that each country typically has its own unique currency, and the exchange rates between one currency and another can change from day to day or hour to hour. Credit cards can allow a person to travel to another country and make a payment, and the credit card company will often charge a foreign transaction fee and perform a currency exchange at the prevailing rate.

Each of the existing forms of payment has substantial problems that can lead to fraud, loss, and other negative outcomes. For example, cash is typically kept in a bank, and must be withdrawn in person or at least at an automated teller machine (ATM) before it can be used. The cash must then be kept secure on a person and not lost or stolen, else it cannot be replaced. Many people hide cash at home where it can be stolen or misplaced. Checks can be printed by anyone that knows a person's bank and account number, and then can be used with only a forged signature. Both checks and debit cards can give a person that obtains them virtually unlimited access to the funds in a person's bank account. Credit cards are not much better, requiring that a person disclose many supposedly secret details with each transaction, such as a credit card number, expiration date, and customer name. Once this information is in the hands of one vendor, it is no longer secret, and can then be used by anyone that has the information. Hardly a week goes by without a news story of some data breach at an online merchant or credit card company in which millions of customer credit card numbers are exposed, along with other customer data. All existing payment systems require customers to give up substantial personal information.

In addition, the more convenient and secure forms of payment often come with an undesirable settlement period, during which the merchant and/or customer takes a risk that the funds are actually there. For example, credit card and check transactions typically settle over a period of days, and even though they may be preauthorized, actions by the customer or other events can cause payments via these methods to fail, leaving a merchant with no idea whether the merchant will receive the promised payment. Electronic draft capture (EDC) refers to the process of swiping a credit card or providing other information (e.g., newer NFC and secure chip technologies) to allow an electronic transaction to take place. EDC involves a settlement process during which a vendor submits a request for payment and a credit card issuer actually moves the money from the customer's account to the vendor over a period of days.

### BRIEF DESCRIPTION OF THE DRAWINGS

FIG. 1 is a block diagram that illustrates components of the universal payment system, in one embodiment.

FIG. 2 is a flow diagram that illustrates processing of the universal payment system to send a payment, in one embodiment.

FIG. 3 is a flow diagram that illustrates processing of the universal payment system to send payments in a corporate mode, in one embodiment.

### DETAILED DESCRIPTION

A universal payment system is described herein that enables more secure, more versatile, faster settling transactions that leverage modern electronic communication infrastructure. Existing payment systems were designed before the presence of smartphones and other electronic communication devices, and thus assume that a rich conversation cannot occur during the transaction between the holder of the funds (e.g., the bank), the customer/payer, and the merchant/payee. In a typical credit card transaction, for example, the merchant might use a modem to communicate with the credit card issuer (e.g., the bank) to authorize the transaction. The credit card issuer assumes the transaction is valid simply because the merchant knows the customer's account number. The credit card issuer will not actually find out if a transaction is invalid until much later, typically days later, when the customer reviews his/her account statement, notices any invalid transactions, and calls the credit card issuer to report the invalid transaction. If this happens, only then will the credit card issuer begin to question the validity of the transaction, often contacting the merchant by letter in the mail to ask for supporting document of the transaction, such as a receipt bearing the customer's signature. This is a lengthy, slow process often referred to as “settlement” of the transaction and it has enabled a great amount of fraud to infiltrate various steps of the system.

The universal payment system begins by recognizing that near instantaneous electronic communication between all of the parties involved is possible today. In particular, the bank can have a conversation with its customer while the customer is still interacting with the merchant. For example, in one embodiment, when the bank is notified by a merchant that a customer wants to pay the merchant money, the bank can at that point send the customer an electronic message asking if the transaction is valid (e.g., “do you wish to pay Merchant X $5?”). If the customer indicates that the transaction is valid, the payment can be quickly transferred to the merchant, with no settlement period needed. It is possible for either the merchant or the customer to initiate the transaction with the system. If the merchant initiates the transaction, then the merchant identifies the customer to the system (e.g. by phone number or email), and if the customer initiates the transaction, then the customer identifies the merchant (e.g., by email, merchant number, or other identifier).

A second observation of the universal payment system is that because of this communication between the bank and customer during the transaction, it is no longer necessary for the customer to provide the merchant with semi-secret information to add a cloud of validity to the transaction. Rather, it is possible for the customer to give some well-known piece of information that identifies the customer, such as the customer's phone number, email address, name, or other identifier. Because the bank will communicate with the customer during the scope of the transaction to determine whether the transaction is valid, no potentially harmful information about the customer, such as a credit card number, has to be shared with the merchant. If the merchant should share the information, such as the customer's phone number, after the transaction, it will not harm the customer because no one else could use that information to perform a second transaction without the customer's authorization.

With these two observations, the universal payment system is designed to overcome the limitations of existing payment systems, and to permit a wide variety of transactions that were difficult before. For example, a transaction overseas that might once have seemed risky for a merchant due to the lengthy settlement period can now happen without a settlement period so that the merchant receives immediate payment as part of the transaction. Likewise, for the customer there is no longer the prospect of having to share sensitive information, such as a credit card number, with someone the customer does not even know. Thus, the universal payment system provides new payment methods for a modern technological environment that are safer and more versatile for all of the parties involved.

In some embodiments, the universal payment system provides additional security features. One type of security feature is asking the user to enter a personal identification number (PIN) or other password when the request arrives on the user's electronic device to complete the transaction. In addition, to thwart key loggers or other attempts to steal the user's PIN, the system may generate a virtual random keyboard for entering the PIN, in which the numbers, letters, or other characters for entering the PIN are in a random location. The user can still find the number or other character the user wants to enter, but the random location thwarts attempts for other parties to learn the PIN.

Another security measure that the universal payment system may employ is not storing customer information. Because the system can complete a transaction with a host-to-host bank transfer, it is not necessary for the system to know information such as a user's credit card numbers and other personal information. Thus, even if the system is somehow compromised, the system does not have enough information to be useful to an attacker or to do harm to the user. Data breaches are common today, and the less information that online systems store, the better for the privacy of users.

In some embodiments, the universal payment system provides a corporate mode in which additional encryption and restrictions are employed. For example, the system may only communicate for payments with a specific SIM and IMEI combination on a smartphone. An IMEI identifies a specific smartphone and a SIM identifies a carrier being used with that smartphone. Using both prevents someone swapping the SIM to try to gain access to the smartphone. The system may allow only the person with the matching IMEI and SIM combination to create payments on behalf of a particular company or other entity. Various roles can be locked to a particular electronic device, such as approver (to approve transactions) and creator (to create transactions). An entity may also set other limitations in this way, such as spending limits, specific vendors that can be paid, and so forth.

In some embodiments, the universal payment system splits the concepts of registration and the PIN. For example, the system may create a one-time password that the user will enter to send a payment. This one-time password may be sent to another electronic device or email associated with the user to provide a second level of verification of the user's identity. For example, when the user is asked if he/she wants to send a payment to Merchant X, the request may ask, “Please enter the code sent to your email if you want to pay Merchant X $10.” In this way, the system knows that both the user is in possession of his/her smartphone or other electronic device and the user can access his/her email or other account. Other security measures can also be used with the system, such as key generating fobs carried by users.

In some embodiments, the universal payment system awards loyalty points in association with transactions sent through the system. For example, the system may provide airline or other points that can be used to buy airline tickets or may be converted into currency to use to pay merchants. As an example, the user might earn one loyalty point for each dollar spent, and then might be able to receive $1 for every 100 points. The loyalty points may be managed by a third party and the system may provide an application programming interface (API) through which the third party communicates with the universal payment system to implement the loyalty points or other features.

In some embodiments, the universal payment system provides a backend system that third parties can integrate with their own payment processes. For example, a restaurant can integrate the system so that customer bills pop up on his/her smartphone and can be paid without receiving anything from the serving staff. As another example, a vendor like Dunkin Donuts can make a specific smartphone or other application that provides a click to pay button to provide an instant transfer of funds that is safer for vendors and then provides the customer with a receipt. The system can provide these and other customized experiences.

In some embodiments, the universal payment system may collect a fee to pay for its operation. For example, the system may collect a 1-3% transaction fee like traditional credit cards on each transaction performed with the system. This compensates the operator of the system and allows the operator to purchase servers, customer support staff, and pay other expenditures involved with operating the system. The system may also be supported by a subscription model, in which either merchants or customers pay a periodic fee to be able to use the system. Other revenue models are also possible, such as the use of advertisements to provide an ad-supported revenue model. By knowing the transactions performed by each customer, the system can provide targeted advertisements that are valued by advertisers.

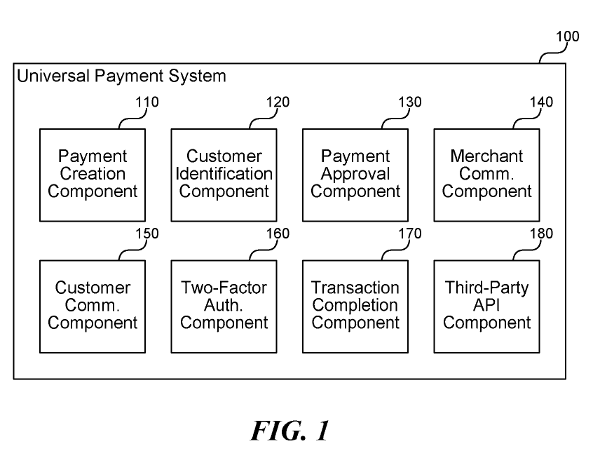

FIG. 1 is a block diagram that illustrates components of the universal payment system, in one embodiment. The system 100 includes a payment creation component 110, a customer identification component 120, a payment approval component 130, a merchant communication component 140, a customer communication component 150, a two-factor authentication component 160, a transaction completion component 170, and a third-party API component 180. Each of these components is described in further detail herein.

The payment creation component 110 initiates a new payment between a merchant and customer through the system 100. The merchant or customer may initiate the payment. For example, a customer may walk into a store, select items for checkout, and provide the merchant with his/her email address or other non-sensitive identification to begin the transaction. The merchant communicates with the system 100, provides the customer identification information and a total transaction amount. The system 100 then creates a payment, looks up the customer, and invokes the approval process of the system 100 to complete the payment. Alternatively, the customer may initiate the payment by communicating with the system 100, providing a merchant ID or other identification and the total transaction amount, and begin the process that way. In this case, the system 100 looks up the merchant and invokes the approval process to complete the transaction. In corporate mode, the system 100 verifies that the party creating the transaction has an appropriate role to do so.

The customer identification component 120 identifies the customer based on non-sensitive information provided by the merchant. For example, the merchant may provide an email address or phone number of the customer to the system 100. The system 100 uses this information to look up the customer in a database or other data store to find the customer's associated electronic communication method and account information. For example, the customer may have an account with a bank associated with the system 100 and a smartphone that is the customer's preferred communication device. Using this information, the system 100 can communicate with the customer to complete the approval process and can transfer funds from the customer's account to the merchant's account to complete the transaction, if approved.

The payment approval component 130 performs electronic communication with the customer during the transaction to receive approval from the customer for the new payment to the merchant. It is this in-transaction, immediate communication that in part differentiates the system 100 from existing payment systems and eliminates the lengthy settlement process to allow for instant funds transfers. The system 100 identifies the appropriate party to approve each transaction, and communicates with that party to determine whether the transaction is authorized. In normal mode, this party is simply the customer, but in corporate mode, this could be multiple parties with varying roles within a company. Only after securing approval from an appropriate party will the system 100 complete a payment.

The merchant communication component 140 communicates between the system 100 and one or more merchants to complete transactions. The merchant communicates with the system 100 to initiate payments, such as by creating an invoice that is sent to the customer. The system 100 communicates with the merchant to provide transaction status and to transfer funds to the merchant's bank account when a transaction is approved. The communication may occur using a variety of methods, such as one or more standard Internet protocols, email, text message, or any other communication method. Because the system 100 does not rely on an exchange of sensitive information between the customer and merchant, the communication method of the system is less restricted because no sensitive information is being transmitted.

The customer communication component 150 communicates between the system 100 and one or more customers to complete transactions. The customer may communicate with the system 100 to initiate transactions and to provide approval once a transaction is created. The system 100 communicates with the customer to send approval requests during a transaction. The system 100 may also communicate with the customer to provide account balance, transaction history, or other reporting information. The communication may occur using a variety of methods, such as one or more standard Internet protocols, email, text message, pop up notifications, and so forth. The system 100 knows a communication method associated with each customer, and the use of the customer's chosen method provides one element of security of the system 100. For example, by knowing the customer's phone number, the system 100 can send a text message to that number that should only be received by the person possessing that phone, the customer.

The two-factor authentication component 160 optionally provides an additional layer of verification of the customer's identity by asking the customer to provide additional information shared by the system 100 and the customer. For example, the system 100 may communicate with the customer using two of the methods described above, such as text message and email, and may ask the customer to reply to a text message with a code sent by the system 100 via email. This provides further verification of the customer's identity because it proves that the customer can access two different modes of communication associated with the customer. Thus even if one of the customer's communication methods becomes compromised by an attacker, the attacker's inability to compromise other communication methods will thwart fraudulent payments.

The transaction completion component 170 transfers funds from the customer to the merchant after receiving approval from the customer. The transfer of funds is a near instant bank-to-bank transfer that requires no typical settlement process like that needed for credit cards. Banks already provide the infrastructure for such transfers, and the system 100 can leverage this existing infrastructure to provide compatibility with hundreds of banking institutions. For a merchant not already recognized by the system 100, the system 100 may request payment information from the customer or merchant about the merchant, so that the system 100 can complete the payment. For example, the system 100 may request an account number identifying an account where the merchant would like to receive the funds. The system 100 may also deduct a fee from the transaction for operation of the system (e.g., 3% of the payment to the merchant).

The system 100 handles any error conditions, such as insufficient funds of the customer in a typical manner, but may have additional non-typical options for resolving such errors. For example, if a merchant requests a payment larger than the customer's current balance, the system 100 may ask the customer during the transaction for another source of funds for completing the transaction. This can eliminate reasons that a transaction might have failed under previous systems.

The system 100 creates a log or audit trail of transactions, both failed and succeeded for providing reports to customers and merchants. The system 100 maintains a balance for each customer and can provide the customer with an account history upon request, such as if the customer wants to receive a monthly statement of transactions, year-end report, and so forth.

The third party API 180 optionally provides access to the system 100 by third parties to provide supplemental services associated with transactions. For example, a third party organization may manage loyalty points associated with each transaction or may provide coupons to customers for specific purchases. These third parties communicate with the system 100 using the third party API, which may include one or more web-based or other programmatic APIs for interacting with the system 100. The API may inform the third party when transactions occur, along with details such as the customer involved, amount of the transaction, merchant, and so forth. The API may receive information from the third party such as points earned, points converted to currency for future purchases, and so on.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

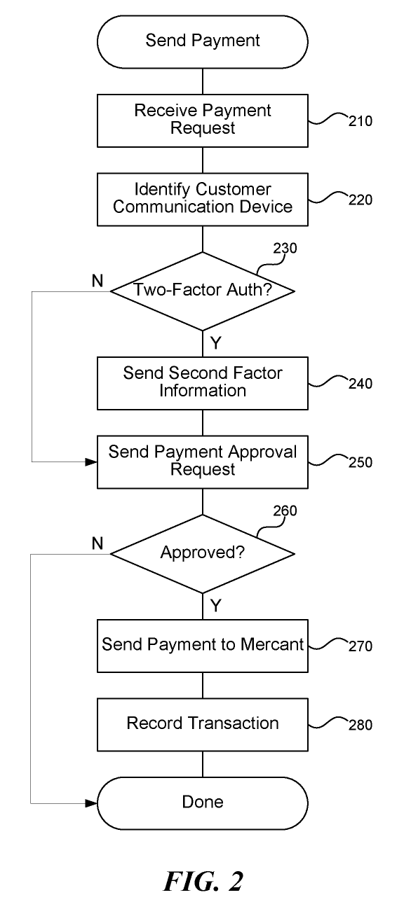

FIG. 2 is a flow diagram that illustrates processing of the universal payment system to send a payment, in one embodiment. Beginning in block 210, the system receives a payment request that identifies a first party to the transaction, a second party to the transaction, and an amount. If the request is initiated by a merchant, then the merchant is the first party and a customer is the second party. If the customer initiates the request, then the customer is the first party and the merchant is the second party. A party is identified using non-secretive information that is commonly used to identify parties of that type. For example, a merchant may have a name, store name, merchant ID, or other identification. A customer might have a name, email address, phone number, or other identifying information. A transaction begins with an identified customer, merchant, and amount of funds to be paid.

Continuing in block 220, the system identifies an electronic communication device associated with the customer through which the system can communicate with the customer during the transaction to obtain transaction approval. The device may be identified generally, such as via a phone number for text message or email address for email, or more specifically such as through a smartphone's IMEI and SIM. In some embodiments, the system may communicate with any one of several of the customer's devices, such as by sending the customer an email that may be received on the customer's laptop, smartphone, tablet computer, or other devices. The customer can then approve the transaction from any device.

Continuing in decision block 230, the system determines whether two-factor authentication should be used. If two-factor authentication is requested, then the system continues at block 240, else the system jumps to block 250. Two-factor authentication may be turned on as a preference by specific customers or may be required by specific implementations of the system for all customers.

Continuing in block 240, the system sends second factor authentication information. For example, the system may generate a PIN and send the PIN via text message or email to the customer, and ask the customer to enter that PIN in another location, such as a custom smartphone application associated with the system or a web page. The second factor information can be any type of information, such as a number, answer to a question, color, or other type of information. The customer's ability to discover the second factor information proves the customer's identity.

Continuing in block 250, the system sends a payment approval request to the customer during the transaction while the customer is still interacting with the merchant. The payment approval request can be a message to a custom smartphone application, a text message, an email message, or any other type of two-way communication method in which the system can send an inquiry to the customer and receive a response from the customer. The request may include transaction details such as the merchant requesting the payment, the amount of the payment, and so forth. The customer approves or denies the request by responding to the communication. For example, if the request is a text message, then the customer might approve the request by replying “yes” and deny the request by replying “no” or ignoring the request. This payment approval request being sent during the transaction differentiates the universal payment system from current payment systems and eliminates the need for a lengthy post-transaction settlement process.

Continuing in decision block 260, if the customer approved the payment request, then the system continues at block 270, else the system completes and does not provide any payment to the merchant. As part of determining whether the customer approved, the system verifies any two-factor authentication information sent matches what was expected and may verify a PIN or other information. In some embodiments, the payment approval process and communication may be extended (not shown) to allow for other steps, such as a series of offers back and forth between the parties. As an example, one embodiment of the system might allow the customer to deny the merchants initial request but to counteroffer with a lower amount, to which the merchant could respond by approving or not.

Continuing in block 270, the system sends payment to the merchant by performing a bank-to-bank transfer of funds from the customer's bank account to the merchant's bank account. This payment completes the transaction without any post-transaction settlement process. Thus, at the close of the transaction the merchant knows a payment has been made and the customer owes no further obligation to the merchant. Contrast this with existing payment systems where even after the transaction the customer may question the payment and the merchant may find the payment later denied.

Continuing in block 280, the system records the transaction to provide an audit trail. The system includes one or more data stores that store transaction and other types of information. The system may provide an account history for each customer and may generate various reports based on the account history that are useful to the customer, such as a monthly statement. After block 280, these steps conclude.

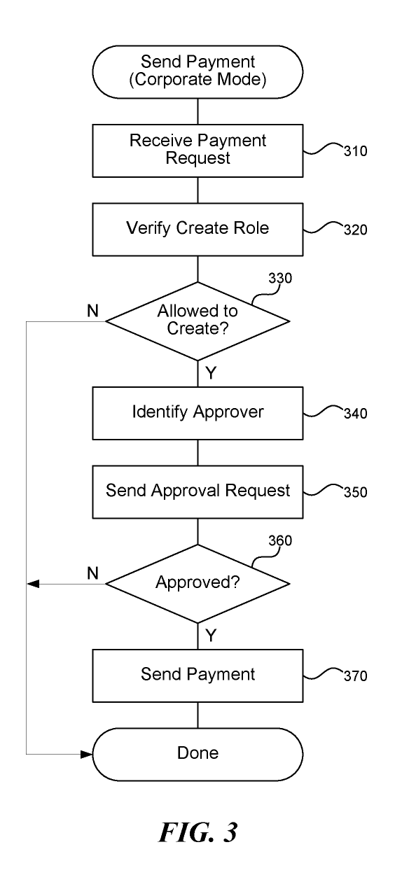

FIG. 3 is a flow diagram that illustrates processing of the universal payment system to send payments in a corporate mode, in one embodiment. Beginning in block 310, the system receives a payment request. Much like block 210 above, the request may be initiated by a merchant or some customer associated with the corporate entity. In many corporate transactions, multiple parties within the corporate entity may be involved in the transaction. For example, supplies may be requested by one party but approved by another party. Rules may be attached to the roles, such as spending limits. One party may be authorized to request and approve transactions below one dollar amount but require a supervisor approval for transactions above that dollar amount. The system can support and enforce these and other types of approval conditions.

Continuing in block 320 the system verifies that a person that initiated the transaction is associated with a payment creation role. The payment creation role indicates which people associated with the corporate entity are approved to create new payments, and may be conditioned on the type of payment, the merchant to which the payment is directed, an amount of the payment, and so forth. For example, a manufacturing department may be limited to purchasing parts from specific identified merchants and may not be able to create payment requests to other merchants.

Continuing in decision block 330, if the person that initiated the transaction is allowed to create the transaction, then the system continues at block 340, else the system completes and denies the transaction.

Continuing in block 340, the system identifies an approver for the transaction. In some cases, the person that initiated the transaction may be the appropriate approver, and then the system continues much like FIG. 2. In other cases, a different approver may be identified, such as a supervisor. The approver may be determined based on the merchant, person that initiated the transaction, the amount, and so forth. For example, transactions up to one amount may go to one supervisor, while transactions up to a higher amount may go to a higher-level supervisor.

Continuing in block 350, the system sends an approval request to the identified approver. The approval request may contain transaction details such as the person associated with the corporate entity that initiated the transaction, the merchant that will receive payment, and the amount of the payment. The approval request may also indicate a purpose for the request, such as purchasing supplies. The approval request may be sent using any of the methods previously described herein, such as email, text message, smartphone app notification, and so on. The approver then provides a reply that approves or denies the transaction.

Continuing in decision block 360, if the approver responded with an approval of the transaction, then the system continues at block 370, else the system completes and does not provide a payment to the merchant.

Continuing in block 370, the system transfers funds from the corporate entity to the merchant. The transfer is near instant and may be performed by bank-to-bank transfer or other method agreed upon by the parties. Because approval for the transaction has been obtained during the transaction, no post-transaction settlement process is needed to verify the transaction. After block 370, these steps conclude.

From the foregoing, it will be appreciated that specific embodiments of the system have been described herein for purposes of illustration, but that various modifications may be made without deviating from the spirit and scope of the invention. Accordingly, the invention is not limited except as by the appended claims.

I/We claim:

1. A computer-implemented method to send a payment using a universal payment system, the method comprising:
receiving a payment request that identifies a merchant to the transaction, a customer to the transaction, and an amount of the transaction;
identifying an electronic communication device associated with the customer through which the system can communicate with the customer during the transaction to obtain transaction approval;
sending a payment approval request to the customer during the transaction while the customer is still interacting with the merchant;
upon determining that the customer approved the payment request, sending payment to the merchant by performing a bank-to-bank transfer of funds from the customer's bank account to the merchant's bank account with no settlement period; and
recording the transaction to provide an audit trail;
wherein the preceding steps are performed by at least one processor.

2. The method of claim 1 wherein receiving the payment request comprises the request is initiated by the merchant.

3. The method of claim 1 wherein receiving the payment request comprises the request is initiated by the customer.

4. The method of claim 1 wherein receiving the payment request comprises identifying the merchant and the customer using non-secretive information that is commonly used to identify parties of that type, including but not limited to a merchant name, a store name, a merchant ID, a customer name, an email address, or a phone number.

5. The method of claim 1 wherein identifying the electronic communication device comprises identifying the device via a telephone number for text message, email address for email, or through a smartphone's IMEI and SIM.

6. The method of claim 1 wherein identifying the electronic communication device comprises communicating with any one of several of the customer's devices whereby the customer can approve the transaction from any identified device.

7. The method of claim 1 further comprising upon determining that two-factor authentication will be used for the transaction, sending second factor authentication information before the transaction is approved.

8. The method of claim 1 wherein sending the payment approval request comprises sending a message to a custom smartphone application, a text message, an email message, or other type of two-way communication method in which the system can send an inquiry to the customer and receive a response from the customer.

9. The method of claim 1 wherein sending the payment approval request comprises the customer approves or denies the request by responding to the communication.

10. The method of claim 1 wherein sending payment comprises at the close of the transaction the merchant knows a payment has been made and the customer owes no further obligation to the merchant.

11. The method of claim 1 wherein recording the transaction comprises the system providing an account history for each customer and merchant.

12. A computer system for providing universal payments and transactions, the system comprising:
a processor and memory configured to execute software instructions embodied within the following components;
a payment creation component that initiates a new payment between a merchant and a customer through the system;
a customer identification component that identifies the customer based on non-sensitive information provided by the merchant;
a payment approval component that performs electronic communication with the customer during the transaction to receive approval from the customer for the new payment to the merchant, while the customer is still interacting with the merchant and without a settlement period;
a merchant communication component that communicates between the system and one or more merchants to complete transactions to initiate payments, to provide transaction status, and to transfer funds to the merchant's bank account after a transaction is approved;
a customer communication component that communicates between the system and one or more customers to complete transactions, wherein the customer communicates with the system to initiate transactions and to provide approval once a transaction is created; and
a transaction completion component that transfers funds from the customer to the merchant after receiving approval from the customer.

13. The system of claim 12 wherein the payment creation component allows the merchant or the customer to initiate the payment by providing non-sensitive identification to begin the transaction.

14. The system of claim 12 wherein the payment creation component includes a corporate mode that verifies a role and authority of the person requesting to create a payment before allowing the payment to be created.

15. The system of claim 12 wherein non-sensitive information is not an account number and is an address associated with the customer such as a telephone number, email address, or postal address.

16. The system of claim 12 further comprising a two-factor authentication component that provides an additional layer of verification of the customer's identity by asking the customer to provide additional information shared by the system and the customer.

17. The system of claim 12 wherein the transaction completion component is performed by a near instant bank-to-bank transfer that requires no typical settlement process like that needed for credit cards.

18. The system of claim 12 further comprising a third-party application programming interface that provides access to the system by third parties to provide supplemental services associated with transactions.

19. A computer-readable storage medium comprising instructions for controlling a computer system to send payments using a universal payment system in a corporate mode, wherein the instructions, upon execution, cause a processor to perform actions comprising:
receiving a payment request that identifies a merchant, a customer, and an amount of a transaction;
verifying that a person that initiated the transaction is associated with a payment creation role, wherein the payment creation role indicates which people associated with a corporate entity are approved to create new payments;
upon determining that the person that initiated the transaction is allowed to create the transaction, identifying an approver for the transaction, wherein the approver is a person other than the person that initiated the transaction;
sending an approval request to the identified approver, wherein the approval request includes transaction details including the customer, merchant, and amount of the transaction;
receiving an approval response from the identified approver; and
transferring funds from the corporate entity to the merchant by bank-to-bank transfer with no post-transaction settlement process.

20. The medium of claim 19 wherein receiving a payment request comprises identifying one or more roles of the customer and one or more rules attached to the roles, including a spending limit, and determining whether to create the transaction based on the customer's spending limit.
